(19) United States
(12) Patent Application Publication
(10) Pub. No.: US 2002/0186251 A1
(43) Pub. Date: Dec. 12, 2002

(54) Method, apparatus and computer program product for context-sensitive scrolling

(75) Inventors: Maria Azua Himmel, Yorktow Heights, NY (US); Herman Rodriguez, Austin, TX (US); Newton James Smith, Jr, Austin, TX (US); Clifford Jay Spinac, Austin, TX (US)

Correspondence Address: Leslie Van Leeuwen, International Business Machines Corporation, Intellectual Property Law Department, 11400 Burnet Road, Internal Zip 4054, Austin, TX, 78758, US

(73) Assignee: International Business Machines Corporation, Armonk, NY

(21) Appl. No.: 09/875,955

(22) Filed: Jun. 7, 2001

(51) Int. Cl. G06F 3/00

(52) U.S. Cl. 345/784

(57) ABSTRACT

A window is generated for displaying information and for scrolling through the information responsive to receiving a scrolling command. Responsive to a user selection, either a non-context-sensitive scrolling mode is enabled, for which a certain one of the scrolling commands scrolls the window by a fixed step size, or a context-sensitive scrolling mode is enabled, for which the same certain one of the scrolling commands scrolls the window by a variable step size responsive to content of the information displayed. In a current position of the window a certain object is top-most in the window. With context-sensitive scrolling enabled, if the end of the top-most object is shown in the current position scrolling steps the window to a next position where a next portion of the information is displayed beginning at the top of a next object after the current top-most object.

### CROSS-REFERENCE TO RELATED APPLICATION

This present application is related to the following co-pending application which has been filed on the same date as the present application, is assigned to the same assignee as the present application and is hereby incorporated herein by reference:

application Ser. No. ______ (Applicant's docket AUS9-2001-0457-US1), “Method, Apparatus and Computer Program Product for Providing Context to a Computer Display Window.”

### FIELD OF THE INVENTION

This invention relates to displaying information on a computerized device, and more particularly to enhanced scrolling of a window displayed by the device.

### BACKGROUND

People are viewing more and more information, particularly Internet web pages, directly on computer displays. Web browsing is now possible with small computerized devices such as personal digital assistants and cell phones. Small computerized devices for reading books are also gaining in popularity. On computer displays, especially small ones, it is difficult for a user to maintain a sense of the context of the information displayed, since so little information fits in the display window. Therefore there is an increasing need for mechanisms which help users maintain their sense of the context of the information displayed on computerized display devices.

### SUMMARY

The present invention involves a recognition that the foregoing need is addressed by improvements in scrolling. That is, in computerized devices a computer program such as a word processing application, a web browser, etc., generates a display. Information such as a word processing document, a web page, etc. is displayed in a window of the display. The program scrolls the window through the information, responsive to user commands from an input device. (Herein reference is made to the window moving, that is scrolling, through the information. It should be understood that movement of the window and information is relative, and that moving the window relative to the information may be considered equivalent to moving the information relative to the window.) Since so little information fits in the display window of a computerized device, particularly for a small device, viewing the information requires a great deal of scrolling. According to the present invention, a scrolling mode is provided that takes into account content of the information displayed.

A touch screen and key pad are common input devices for personal digital assistants which have relatively small displays; a mouse and keyboard are more common for larger devices. The keypad and keyboard are examples of discrete step input devices which conventionally allow the user to move a cursor or command the display window to scroll through the data in discrete steps. The touch screen and mouse are both examples of pointing devices, which conventionally allow the user to position a cursor on the display window or scroll the window with much greater precision, i.e., by more nearly continuous display coordinates. In another aspect of the present invention, scrolling is stepwise for both pointer and discrete step input device controlled scrolling. The step sizes are variable, depending upon the content of the information that is displayed in the window. In this way a more nearly optimal amount of context is retained from one position of the display window to the next.

In the case of scrolling under control of the pointing device for the present invention, speed of the scrolling is also controllable by the pointer, but the scrolling does not move the window continuously through the information. Instead, even under pointer control scrolling is by discrete steps. Accordingly, the window scrolls down through the information in steps, pausing at least briefly after each step to display the information at contextually-determined points. The speed or extent of scrolling affects the duration of the pauses. This is in contrast to conventional pointer controlled scrolling, where the information shown in the window has a constantly shifting motion that makes it difficult for the user's eyes to follow the information. According to this aspect of the present invention, the window does not move continuously through the information, but rather EL first portion of the information is continuously displayed, without moving, in a current position of the window for an interval of time, and then a next portion of the information is continuously displayed, again without moving, in a next position of the window, and so on. This allows the user to concentrate on the information itself without being distracted by the way that the information is being presented to the user, since the window contents spends less time in motion and more time displayed in a fixed position.

Other objects and advantages of the invention will become apparent upon reading the following detailed description and upon reference to the accompanying drawings.

### BRIEF DESCRIPTION OF THE DRAWINGS

FIG. 1 illustrates scrolling in accordance with prior art.

FIGS. 2A and 2B illustrate scrolling through a succession of paragraphs, in accordance with an embodiment of the present invention.

FIGS. 3A and 3B illustrate further details of scrolling through a succession of paragraphs, in accordance with an embodiment of the present invention.

FIG. 4 illustrates another aspect of details of scrolling through a succession of paragraphs, in accordance with an embodiment of the present invention.

FIG. 5 illustrates certain aspects of a computer program for an embodiment of the present invention, including selection of different scrolling modes.

FIGS. 6A and 6B illustrate certain aspects of determining the variable step size for scrolling in a context scrolling mode, according to an embodiments of the present invention.

FIG. 7 illustrates a computerized device for displaying and scrolling through information, in accordance with an embodiment of the present invention.

### DETAILED DESCRIPTION

The claims at the end of this application set out novel features which applicants believe are characteristic of the invention. The invention, a preferred mode of use, further objectives and advantages, will best be understood by reference to the following detailed description of an illustrative embodiment read in conjunction with the accompanying drawings.

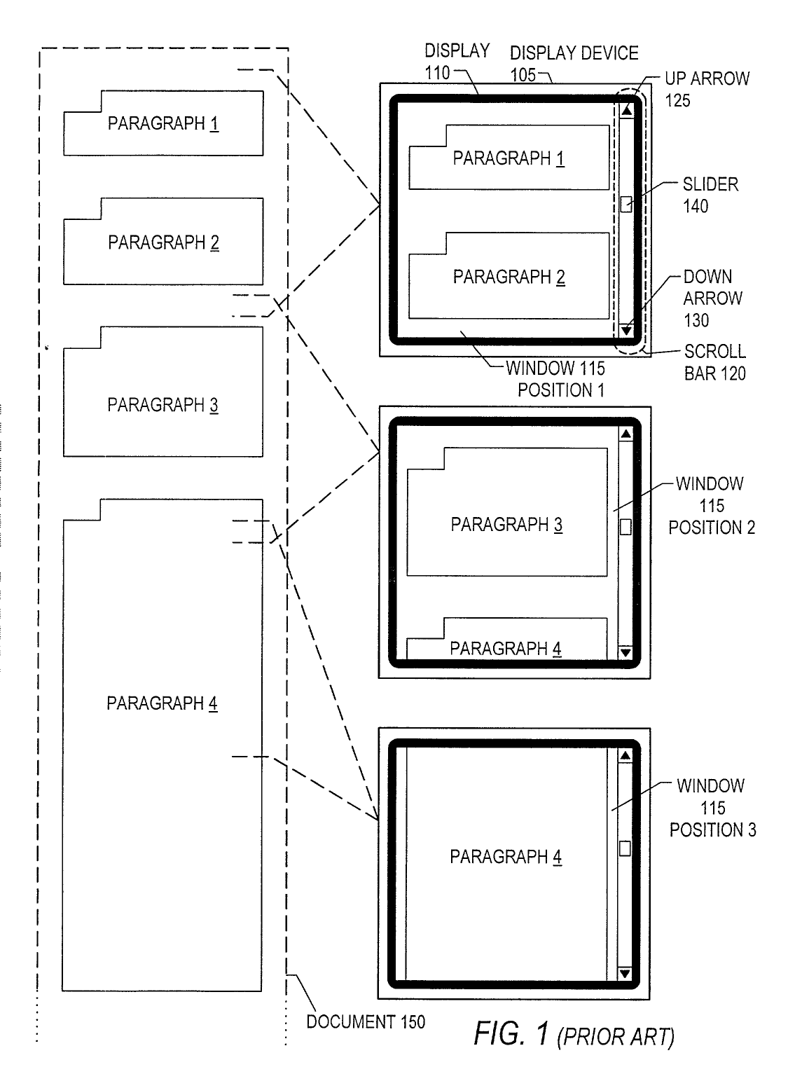

Referring now to FIG. 1, in which scrolling is illustrated according to the prior art, on the left-hand side of the FIG. a document 150 is illustrated. The document 150 includes a succession of paragraphs, four of which are shown, that is, paragraphs 1 through 4. On the right-hand side of the figure is shown three instances of a window 115 of a display 110 on a display device 105 in this particular illustration. In the illustration, the window 115 a shown filling nearly the entire display 110, but it should be understood that the window may be much smaller, and that a number of windows can be open at one time on the display 110. The display 110 is a physical portion of the display device 105, whereas the window 115 is a logical object. Each of the instances illustrates a respective position of the window 115 in which a portion of the word processing document 150 is displayed. A computer program (not shown), such as a word processing application in connection with an operating system, generates the window 115. The program scrolls the window 115 through the document 150, responsive to user commands from an input device (not shown) such as a mouse or keyboard. A touch screen and key pad are also common input devices for personal digital assistants which have relatively small displays.

The window has a vertical scroll bar 120 since the vertical length of the document 150 exceeds that of the window 115. If the horizontal width of the document 150 were to exceed the horizontal width of the window 115, then the window would also have a horizontal scroll bar. The one or more scroll bars provide means to scroll the window 115 through the document 150. The vertical scroll bar 120 is now further described, but it should be understood that the description applies correspondingly to the horizontal scroll bar.

The vertical scroll bar 120 runs substantially the entire vertical length of the window 115, and has a slider 140. The size of the slider 140 depends on the vertical length of the window 115 relative to the vertical length of the document 150. In one user command for scrolling the information, the user drags the slider 140 either up or down using a pointing device (not shown). Dragging the slider 140 downward scrolls the window 115 down through the document 150, and dragging it upward scrolls the window 115 up through the document 150.

At the top of the vertical scroll bar 120 is an up arrow 125. At the bottom of the vertical scroll bar 120 is a down arrow 130. In another user command for scrolling the document 150, the user selects the up or down arrow with a pointing device. Selecting the down arrow scrolls the window down through the document 150, and, of course, selecting the up arrow scrolls the window up. If one of the arrows is selected momentarily, the window moves one time by a fixed amount, such as one line. If the arrow is selected for a longer time, such as by holding down a button on a pointing device (not shown), the window scrolls continuously as long as the arrow is selected.

In another user command for scrolling the document 150, the user depresses keys on the keyboard. For example, depressing the “down arrow” key on the keyboard scrolls the window 115 down through the document 150 one line at a time, and depressing the “page down” key scrolls the window down through the document 150 one window at a time. In FIG. 1 the three instances shown are for three successive positions of the window, where the window has been moved down using the “page down” key. As indicated, each successive position begins at the last line of the previous position. That is, each position moves down by the amount of the vertical length of the window less one single line, so that each successive position overlaps the last position by a single line.

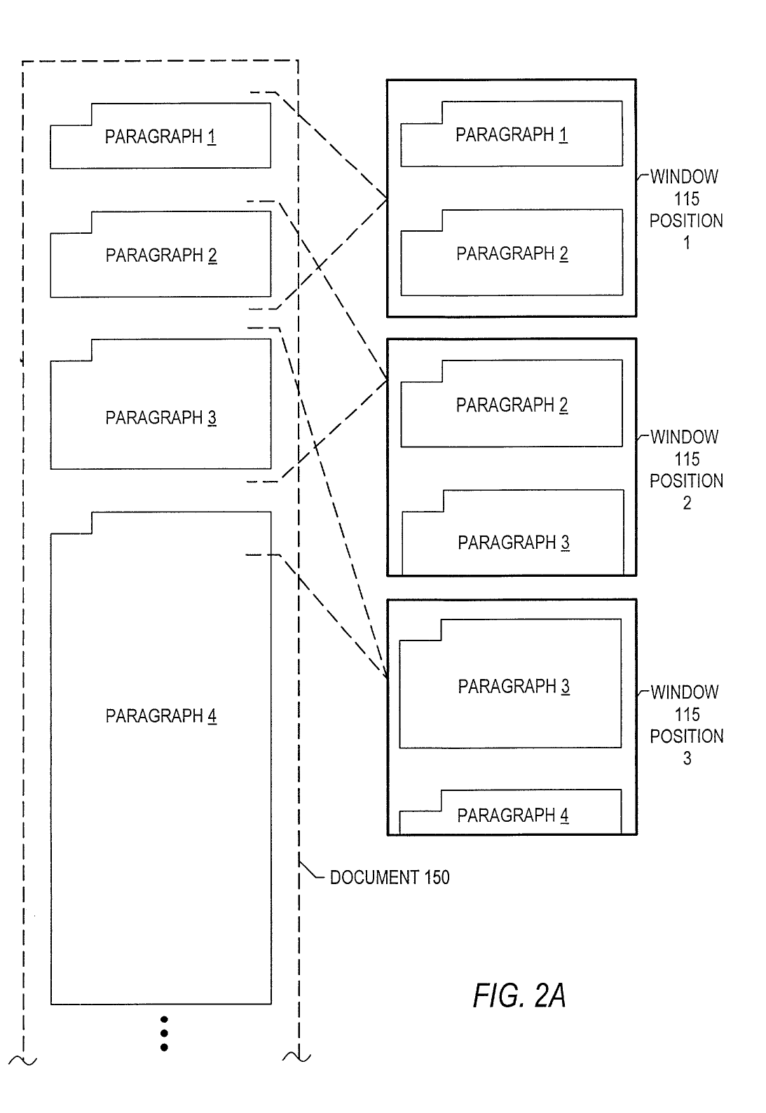

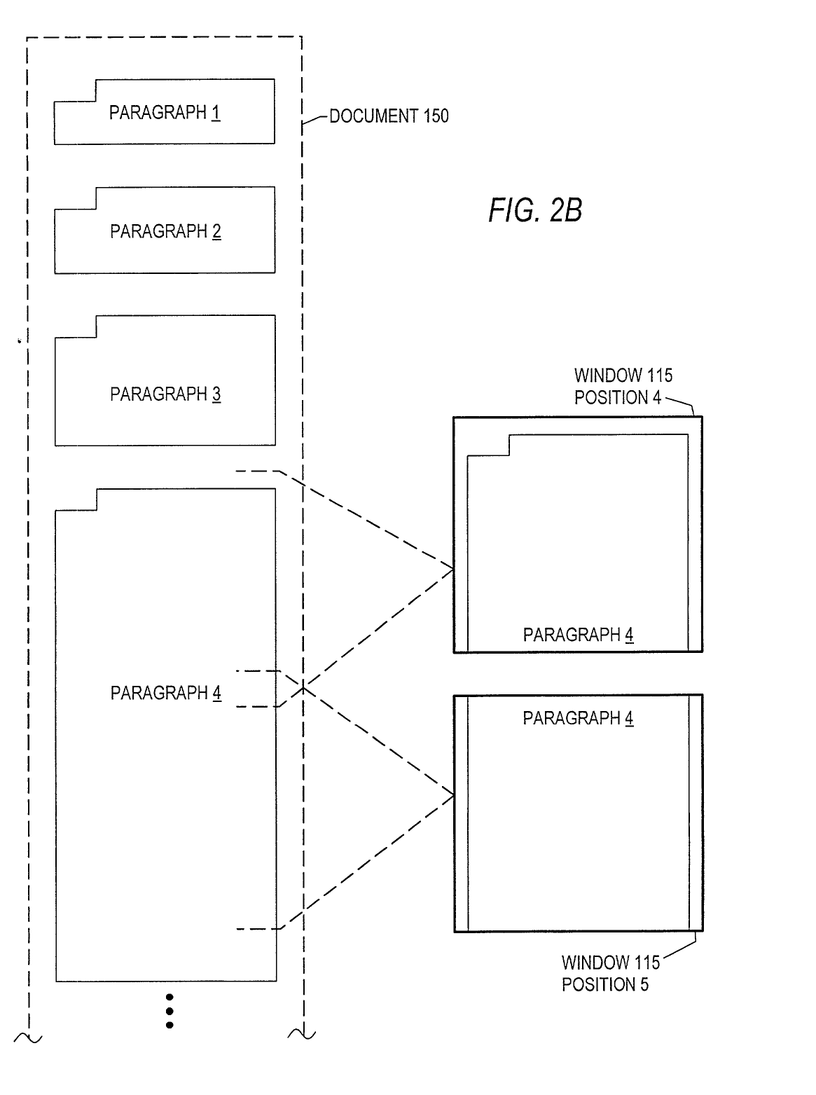

Referring now to FIGS. 2A and 2B, aspects of scrolling according to an embodiment of the present invention are illustrated. With the window 115 in the first position, the first paragraph is displayed with the top of the first paragraph at the top of the window 115. Since the first paragraph is small enough relative to the window 115 that the whole paragraph is displayed in the window 115, when the window 115 scrolls down it steps to a second position with the next succeeding paragraph, paragraph 2, displayed at the top of the window 115. Likewise, in the second position the second paragraph is small enough relative to the window 115 that the whole paragraph is displayed in the window 115. Therefore, when the window 115 scrolls down again it steps to a third position with the next succeeding paragraph, paragraph 3, displayed at the top of the window 115.

In the third position of the window 115, paragraph 3 is small enough relative to the window 115 that the whole paragraph is displayed. Therefore, when the window 115 scrolls down again it steps to a fourth position, shown in FIG. 2B, with the next succeeding paragraph, paragraph 4, displayed at the top of the window 115. The fourth paragraph is too large for the whole paragraph to be displayed in the window 115. The next scrolling will therefore step down the fourth paragraph to position 5 as shown.

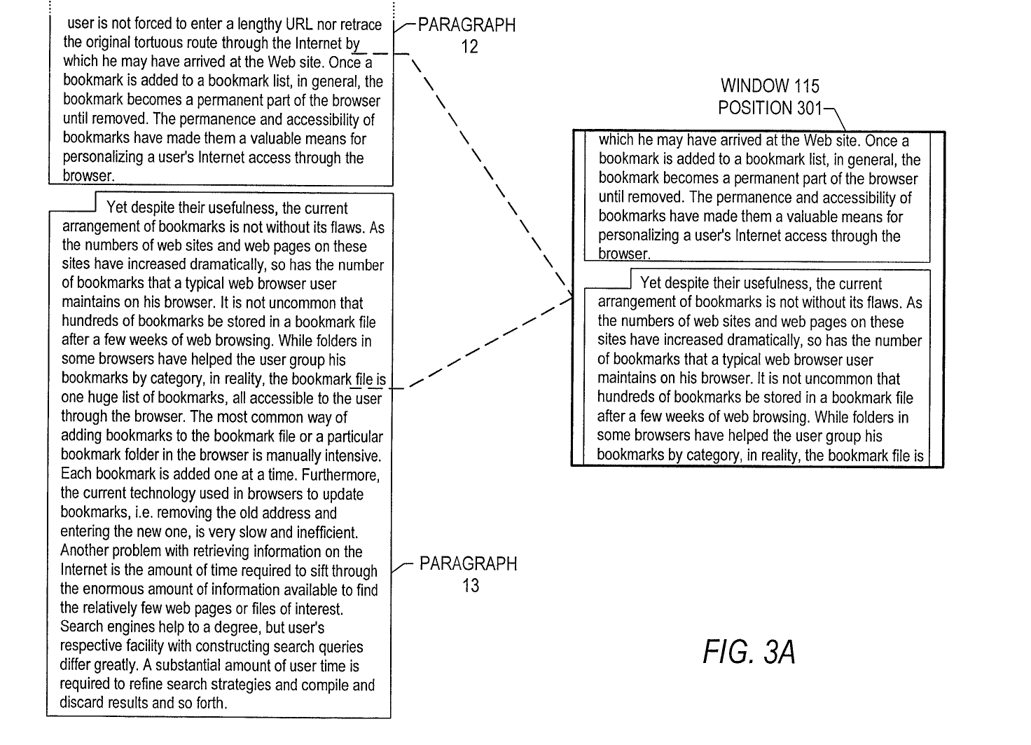

Referring now to FIGS. 3A and 3B, aspects of scrolling according to an embodiment of the present invention are illustrated for scrolling within a relatively large paragraph, paragraph 13. This scrolling is in a certain manner that takes into account not only paragraph context, but sentence context as well.

FIG. 3A illustrates that beginning from position 301, where the last portion of paragraph 12 and the first portion of paragraph 13 are shown, the window 115 next scrolls down to a next position in FIG. 3B.

In FIG. 3B line numbers 310 through 345 of document 150 are shown on the left. On the right two instances of window 115 are shown, i.e., in positions 302 and 303. In position 302 of the window 115, the top of the window 115 begins at the top of paragraph 13. That is, the first line of the window 115 shows line 319 of the document 150. Since paragraph 13 is too large to fit in the window 115 and the beginning of paragraph 13 is in the window, it is inherent, of course, that at least a portion of a certain sentence in the paragraph is displayed at the bottom of the window 115 in position 302, as shown. (The sentence begins on line 333 and is shown in FIG. 3B with dashed lines around it.)

Position 303 of the window 115 illustrates the next scrolling position, in which the sentence that was at the bottom of the window 115 in the previous position, position 302, is now at the top of the window 115. That is, now line 1 of the window 115 shows line 333 of the document 150. According to an embodiment, regardless of whether the last sentence shown at the bottom of the window 115 in position 302 is shown in its entirety or a portion of it is cut off, the window 115 will scroll to the next position, as shown in FIG. 3B position 303, with the sentence that was at the bottom of the window 115 in position 302 now at the top of the window 115.

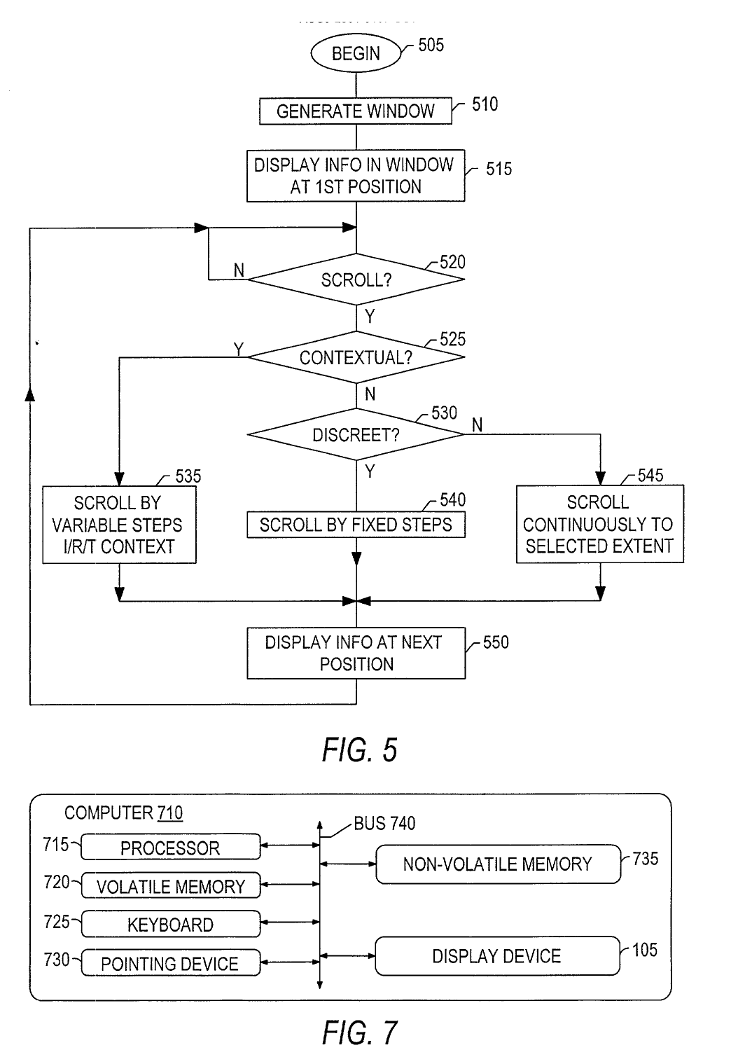

Referring now to FIG. 5, certain aspects of a computer algorithm are illustrated for an embodiment of the present invention, including selection of different scrolling modes. In this and the other algorithms described in this application it should be understood that events depicted do not necessarily have to occur in the sequence illustrated in the figures. The algorithm begins at 505, and generates a window at 510. At 515 information is displayed in the window for a first position. At 520 the algorithm monitors for a scrolling command from the user. When a scrolling command is detected, then at 525 the algorithm determines whether a context sensitive scrolling mode has been selected. If not, then depending on whether the scrolling command input is from a discrete step input device or a pointing device at 530, the algorithm scrolls by fixed scrolling steps at 540 responsive to the discrete step input device, or scrolls continuously to the extent selected by the pointer input device at 545.

If context sensitive scrolling has been selected at 525, then scrolling occurs by a variable scrolling step at 535, where the size of the scrolling step is responsive to the content of the information being displayed. (In FIG. 5 “in response to” is abbreviated as “I/R/T.”) This even includes scrolling by dragging the slider 140, according to the embodiment. That is, for context sensitive scrolling under control of the pointer the window does not move continuously through the document. For example, if the pointer drags the slider downward a vertical distance that is many times greater than the vertical length of the window, the window steps down through the document numerous times, pausing at least briefly after each step to display the information at the appropriate contextually-determined point.

Thus, even under pointer control, scrolling is by discrete steps and includes automatic pauses. The speed and extent of scrolling affects the duration of the pauses. If the scrolling is slow, e.g., the slider is dragged slowly, the pauses are long, but if the scrolling is fast the pauses are more brief. If the slider is dragged or autoscrolled a shorter distance the pauses are longer, but if the slider is dragged or autoscrolled a longer distance the pauses are more brief.

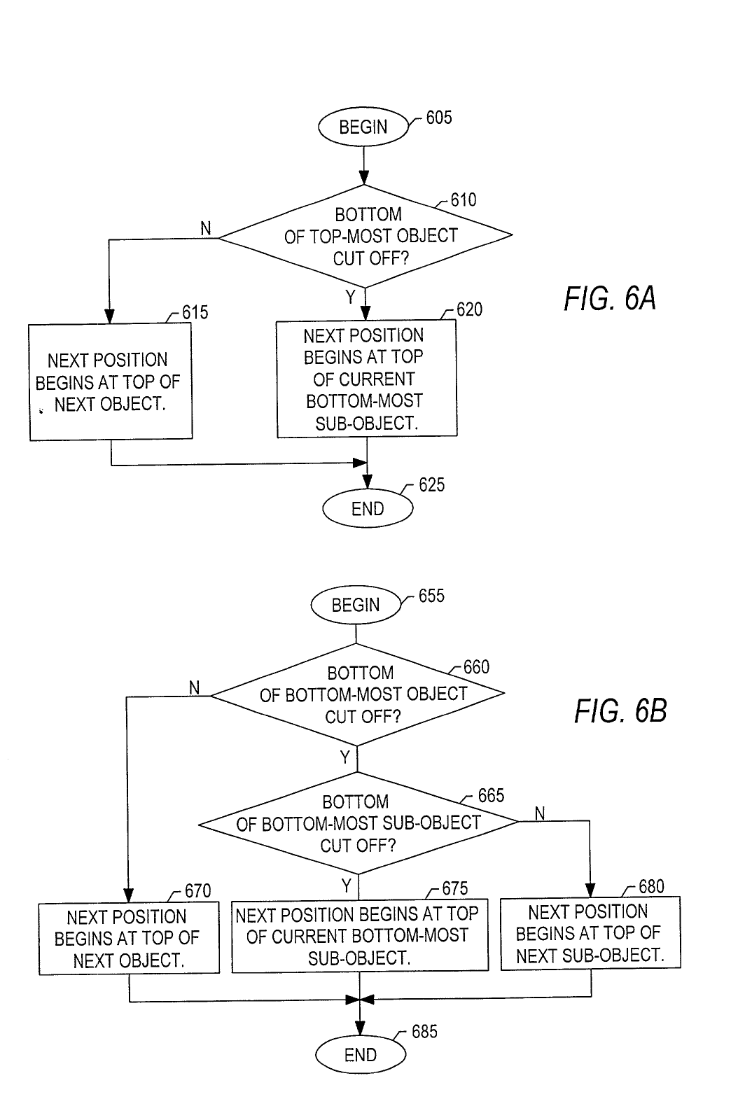

It should be understood from the foregoing that the same user scrolling command will cause the window to scroll by a fixed size scrolling step if non-context sensitive scrolling is enabled, but will cause the window to scroll by a variable size scrolling step if context sensitive scrolling is enabled. In the prior art, as illustrated in FIG. 1, scrolling by the keyboard conventionally causes the window 115 to scroll in fixed steps; that is, the window 115 jumps in discrete steps through the document 150 one line at a time, in the case of pressing the “down arrow” key, or one window at a time, in the case of pressing the “page down” key., etc. However, according to an embodiment of the present invention, in the context sensitive scrolling mode the “page down” key causes scrolling to move object-by-object, as has been described above. Referring now to FIG. 6A, certain aspects of determining the variable step size for downward scrolling in a context scrolling mode are illustrated, according to an embodiment of the present invention. The algorithm begins at 605, and at 610 determines for the current position of the window whether a bottom portion of the top-most object in the window is cut off. If the object is not cut off, then at 615 the algorithm determines that in the next position the top of the window will begin at the next object. If the object is cut off, then at 620 the algorithm determines that in the next position the top of the window will begin at the top of the current bottom-most sub-object, i.e., the sub-object that has at least a portion of the sub-object displayed in the current position of the window. Having determined where the next position of the window will begin, this aspect of the algorithm ends at 625.

Referring now to FIG. 6B, certain aspects of determining the variable step size for downward scrolling in a context scrolling mode are illustrated, according to an alternative embodiment of the present invention. The algorithm begins at 655, and at 660 determines for the current window position whether the bottom-most object in the window is displayed in its entirety, or whether a portion of it is cut off. If the object is shown in its entirety, i.e., is not cut off, then at 670 the algorithm determines that in the next position the top of the window will begin at the top of the next object. If the object is cut off, then at 665 the algorithm determines whether the bottom-most sub-object that is displayed in the current window position is also cut off. If not, the algorithm determines at 630 that in the next position the top of the window will begin at the next sub-object. If the last sub-object is cut off, then at 675 the algorithm determines that in the next position the top of the window will begin at the top of the last sub-object. Having determined where the next position of the window will begin, the algorithm ends at 685.

Referring again to FIG. 2A, an aspect of the above alternative is further illustrated. With the window 115 in position 1, since both paragraphs 1 and 2 fit in the window 115, paragraph 2 is the bottom-most one of the paragraphs and is not cut off at the bottom. Therefore, in the alternative embodiment, the variable step size is of such a size that the window 115 steps down to a next position, position 3 in FIG. 2A instead of position 2. In position 3 the window 115 displays a next portion of the document beginning at the top of paragraph 3, which is the next paragraph after paragraph 2.

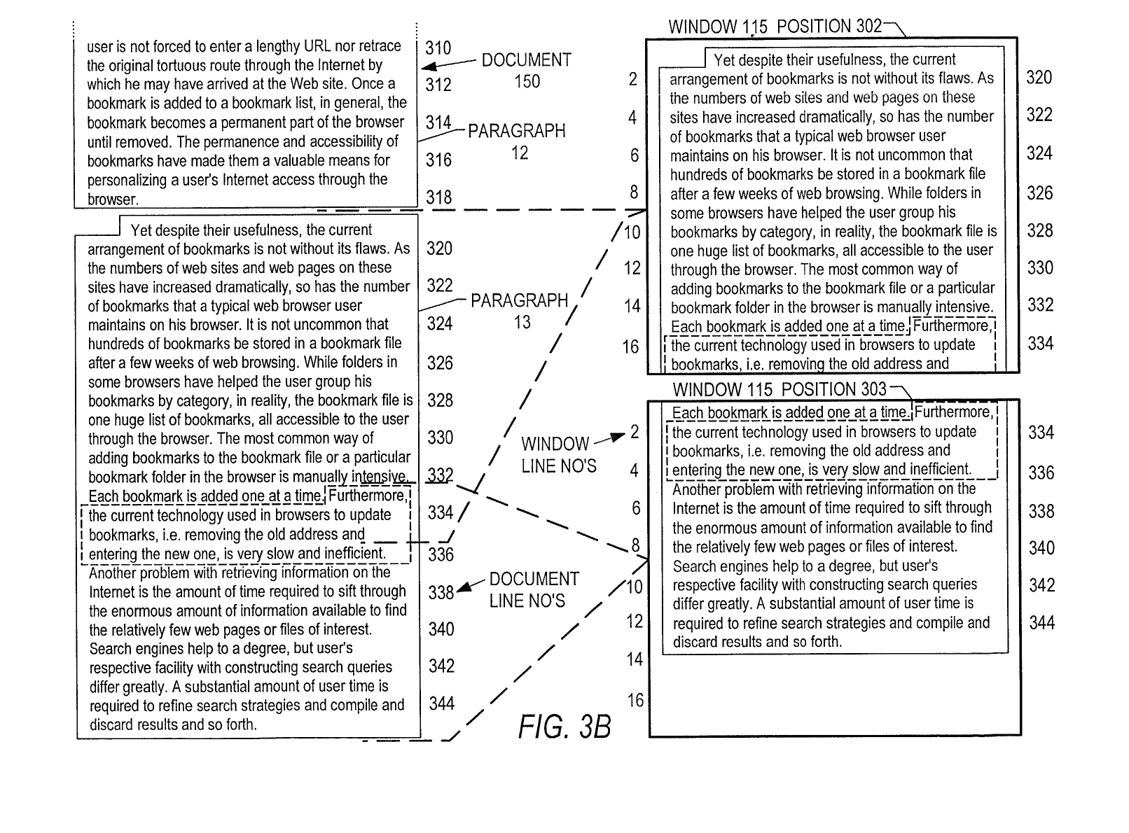

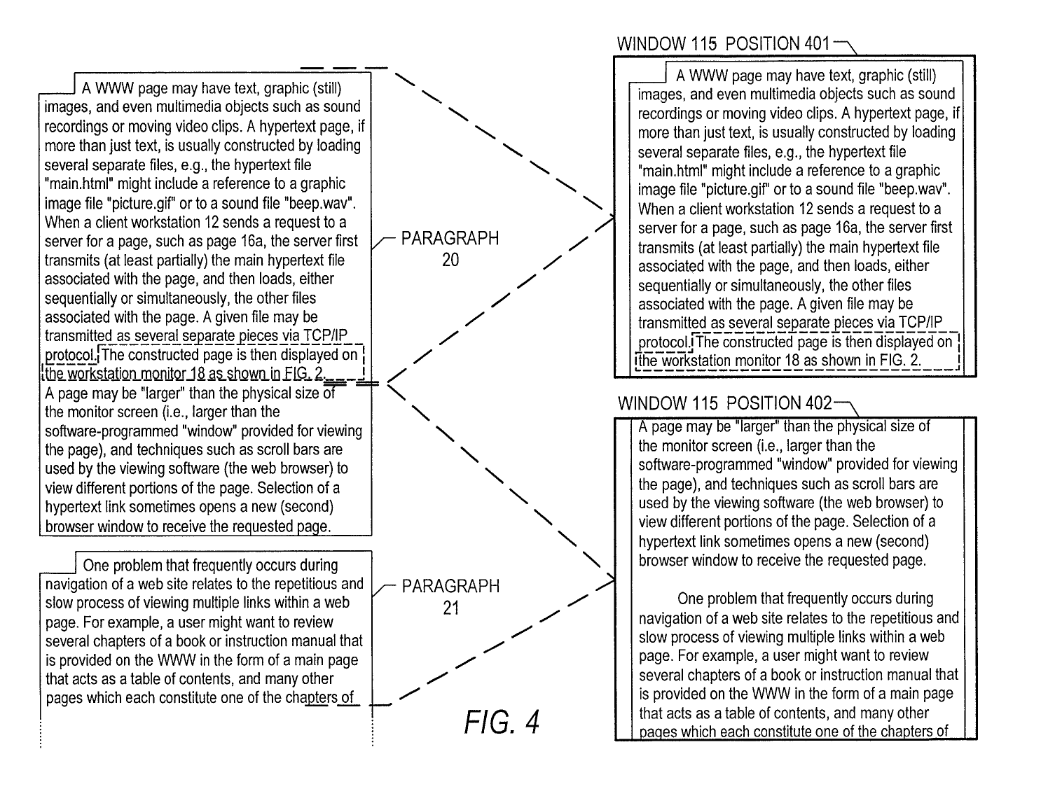

Referring now to FIG. 4, another aspect of the alternative embodiment is shown. In FIG. 4 paragraph 20 is cut off at the bottom of the window 115 in position 401. In this position the bottom-most displayed sentence is displayed in its entirety. Because the bottom-most sentence in position 401 is not cut off, in the next position downward, position 402, the top of the window 115 is at the beginning of the next sentence after the sentence that is position 401's bottom-most sentence.

Referring now to FIG. 7, a computerized device 710 is shown that is generally applicable for the embodiment described. The computer 710 has a processor 715, a volatile memory 720 (that is, RAM), a keyboard 725, a pointing device 730, a nonvolatile memory 735 (for example, ROM, hard disk, floppy disk, CD-ROM, etc.), and a display device 105. The memory 720 and 735 are for storing a program for controlling the processor 715, and the processor is operative with the program to perform as described herein. The display device 105 shown could use a cathode ray tube (“CRT”), liquid crystal, field emission device, or some other type of display element. These components in the device 710 are interconnected by bus 740. The keyboard is a discrete step input device. In other embodiments a discrete step input device is a microphone for receiving voice commands, or a keypad. In other embodiment, the display device 105 is an audio device, and in the context sensitive scrolling mode the scrolling operations are responsive to content of an audio recording, such as a pause in the sound, a verse, a stanza, a refrain, an interlude, a movement, a chorus, etc. In another embodiment, the display device is an audio-video device, and in the context sensitive scrolling mode the scrolling operations are responsive to content of an audio-video recording, such as an act, a scene, a commercial, a quarter, half, highlight, play or time out of a sporting event, etc. In another aspect, if the user or developer of information creates bookmarks in the information, the scrolling operations are responsive to the bookmarks.

It is important to note that while the present invention has been described in the context of a fully functioning data processing system, those of ordinary skill in the art will appreciate that the processes of the present invention are capable of being distributed in the form of a computer readable medium of instructions in a variety of forms and that the present invention applies equally regardless of the particular type of signal bearing media actually used to carry out the distribution. Examples of computer readable media include RAM, flash memory, recordable-type media, such a floppy disk, a hard disk drive, a ROM, and CD-ROM, and transmission-type media such as digital and analog communications links, e.g., the Internet.

The description of the present embodiment has been presented for purposes of illustration, but is not intended to be exhaustive or to limit the invention to the form disclosed. Many modifications and variations will be apparent to those of ordinary skill in the art. For example, downward scrolling is described in the examples used herein, but it should be understood that the description applies equally to horizontal or upward scrolling. Also the content to which the contextual scrolling responds is described as paragraph and sentence type objects. It should be understood however that the invention applies to a wide variety of objects, including but not necessarily limited to one of the following objects: sections, divisions, chapters, rows, columns, cells, hypertext links, or pictorial images, etc. The invention applies to a wide variety of programs for generating such display objects, including but not necessarily limited to any of the following application programs: word processor, web browser, spreadsheet, electronic book reader, or data base applications. Likewise, the description herein has largely referred to a “document” that the window scrolls through. It should be understood that the invention is applicable to a wide variety of information besides documents such as those created and edited by word processor applications. The invention is applicable to information including but not necessarily limited to the following: web pages, spreadsheets, databases, books, magazines, newspapers, audio books, voice mail, audio recordings, audio-video recordings, etc.

In an additional aspect, since there are quite a number of types of objects, in one embodiment a user preference selection menu is provided. The user may use this menu to select types of objects to which the scrolling responds. The user preferences selection menu also includes a default set of object types which the user may elect to accept instead of personally selecting objects.

To reiterate, the embodiments were chosen and described in order to best explain the principles of the invention and its practical applications, and to enable others of ordinary skill in the art to understand the invention. Various other embodiments having various modifications may be suited to a particular use contemplated, but may be within the scope of the present invention.

What is claimed is:

1. A method for scrolling comprising the steps of:
generating a window, for displaying information and scrolling through the information responsive to receiving a scrolling command; and
enabling, responsive to a user selection, either i) a non-contextual scrolling mode, for which a certain one of the scrolling commands scrolls the window by a fixed step size, or ii) a context-sensitive scrolling mode, for which the same certain one of the scrolling commands scrolls the window by a variable step size responsive to content of the information displayed.

2. The method of claim 1, wherein the information includes a succession of objects and in a current position the window displays a first portion of the information beginning at the top of the widow and ending at the bottom of the window, the method comprising the step of:
scrolling downward with the context-sensitive scrolling mode enabled, wherein if in the current position of the window an object is a bottom-most one of the objects and has a bottom end shown, then the variable step size is of such a size that the window steps down to a next position wherein the window displays a next portion of the information beginning at the top of a next object after the current bottom-most object.

3. The method of claim 1, comprising the step of receiving a command for context-sensitive scrolling from a pointing input device or a discrete step input device.

4. The apparatus of claim 3, wherein the discrete step input device is a keyboard, a keypad or a microphone.

5. The method of claim 3, wherein the pointing input device is a mouse, a trackball, a light pen, a touch screen, a track point, or a touch pad.

6. The method of claim 1, wherein for a context-sensitive scrolling command received from a pointing input device, if a commanded scrolling movement exceeds a single scrolling step size, then the widow steps down multiple times through the information, pausing to display the information after each step.

7. The method of claim 6, wherein the pauses are more brief for a larger commanded scrolling movement than for a smaller scrolling movement.

8. The method of claim 6, wherein the pauses are more brief for a faster commanded scrolling movement than for a slower scrolling movement.

9. The method of claim 1, wherein the content to which the context-sensitive scrolling responds is: a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark.

10. A method for scrolling comprising the steps of:
generating a window, for displaying information and scrolling through the information responsive to a scrolling command, wherein in a current position the window displays a first portion of the information beginning at the top of the widow and ending at the bottom of the window; and
scrolling downward with a context-sensitive scrolling mode enabled, wherein if in the current position an object is a top-most object in the window and has a bottom-most end shown, then the window steps down to a next position wherein the window displays a next portion of the information beginning at the top of a next object after the current top-most object; and
scrolling downward with a context-sensitive scrolling mode enabled, wherein if in the current position the top-most object is cut off at the bottom of the window and has a bottom-most sub-object, then the window steps down to a next position wherein the window displays a next portion of the information beginning at the top of the current bottom-most sub-object.

11. The method of claim 10 wherein the current top-most object has a certain sub-object that is a bottom-most sub-object shown in the current position of the window, the method comprising the step of:
scrolling downward with a context-sensitive scrolling mode enabled, wherein if in the current position the top-most object is cut off at the bottom of the window and its bottom-most sub-object has a bottom-most end shown, then the window steps down to a next position wherein the window displays a next portion of the information beginning at the top of a next sub-object after the current bottom-most sub-object.

12. The method of claim 10, comprising the step of receiving a command for context-sensitive scrolling from a pointing input device or a discrete step input device.

13. The method of claim 12, wherein the pointing input device is a mouse, a trackball, a light pen, a touch screen, a track point or a touch pad.

14. The apparatus of claim 12, wherein the discrete step input device is a keyboard, a keypad or a microphone.

15. The method of claim 10, wherein for a context-sensitive scrolling command received from a pointing input device, if a commanded scrolling movement exceeds a single scrolling step size, then the widow steps down multiple times through the information, pausing to display the information after each step.

16. The method of claim 15, wherein the pauses are more brief for a larger commanded scrolling movement than for a smaller scrolling movement.

17. The method of claim 15, wherein the pauses are more brief for a faster commanded scrolling movement than for a slower scrolling movement.

18. The method of claim 10, wherein the content to which the context-sensitive scrolling responds is: a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark.

19. An apparatus for scrolling information on a display device, the apparatus comprising:
a processor;
a display device connected to the processor;
a user input device connected to the processor; and
a storage device connected to the processor, wherein the storage device is for storing a program for controlling the processor, and the processor is operative with the program to generate a window, for displaying information and scrolling through the information responsive to receiving a scrolling command, and the processor is operative with the program to enable, responsive to a user selection, either i) a non-contextual scrolling mode, for which a certain one of the scrolling commands scrolls the window by a fixed step size, or ii) a context-sensitive scrolling mode, for which the same certain one of the scrolling commands scrolls the window by a variable step size responsive to content of the information displayed.

20. The apparatus of claim 19, wherein the information includes a succession of objects and in a current position the window displays a first portion of the information beginning at the top of the widow and ending at the bottom of the window, and wherein the processor is operative with the program to scroll downward with the context-sensitive scrolling mode enabled, wherein if in the current position of the window an object is a bottom-most one of the objects and has a bottom end shown, then the variable step size is of such a size that the window steps down to a next position wherein the window displays a next portion of the information beginning at the top of a next object after the current bottom-most object.

21. The apparatus of claim 19, wherein in a current position the window displays a first portion of the information beginning at the top of the widow and ending at the bottom of the window, and wherein the processor is operative with the program to do the following:
scroll downward with a context-sensitive scrolling mode enabled, wherein if in the current position an object is a top-most object in the window and has a bottom-most end shown, then the window steps down to a next position wherein the window displays a next portion of the information beginning at the top of a next object after the current top-most object; and
scroll downward with a context-sensitive scrolling mode enabled, wherein if in the current position the top-most object is cut off at the bottom of the window and has a bottom-most sub-object, then the window steps down to a next position wherein the window displays a next portion of the information beginning at the top of the current bottom-most sub-object.

22. The apparatus of claim 21, wherein the current top-most object has a certain sub-object that is a bottom-most sub-object shown in the current position of the window, and wherein the processor is operative with the program to scroll downward with a context-sensitive scrolling mode enabled, wherein if in the current position the top-most object is cut off at the bottom of the window and its bottom-most sub-object has a bottom-most end shown, then the window steps down to a next position wherein the window displays a next portion of the information beginning at the top of a next sub-object after the current bottom-most sub-object.

23. The apparatus of claim 22 comprising a pointing input device for inputting the command for context-sensitive scrolling.

24. The apparatus of claim 23, wherein the pointing input device is a mouse, a trackball, a light pen, a touch screen, a track point or a touch pad.

25. The apparatus of claim 22 comprising a discrete step input device for inputting the command for context-sensitive scrolling.

26. The apparatus of claim 25, wherein the discrete step input device is a keyboard, a keypad or a microphone.

27. The apparatus of claim 22, wherein for a context-sensitive scrolling command received from a pointing input device, if a commanded scrolling movement exceeds a single scrolling step size, then the widow steps down multiple times through the information, pausing to display the information after each step.

28. The apparatus of claim 22, wherein the pauses are more brief for a larger commanded scrolling movement than for a smaller scrolling movement.

29. The apparatus of claim 22, wherein the pauses are more brief for a faster commanded scrolling movement than for a slower scrolling movement.

30. The apparatus of claim 22, wherein the content to which the context-sensitive scrolling responds is: a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark.

31. A computer program product for scrolling comprising the steps of:
instructions for generating a window, for displaying information and scrolling through the information responsive to receiving a scrolling command; and
instructions for enabling, responsive to a user selection, either i) a non-contextual scrolling mode, for which a certain one of the scrolling commands scrolls the window by a fixed step size, or ii) a context-sensitive scrolling mode, for which the same certain one of the scrolling commands scrolls the window by a variable step size responsive to content of the information displayed.

32. The computer program product of claim 31, wherein the information includes a succession of objects and in a current position the window displays a first portion of the information beginning at the top of the widow and ending at the bottom of the window, the computer program product comprising:
instructions for scrolling downward with the context-sensitive scrolling mode enabled, wherein if in the current position of the window an object is a bottom-most one of the objects and has a bottom end shown, then the variable step size is of such a size that the window steps down to a next position wherein the window displays a next portion of the information beginning at the top of a next object after the current bottom-most object.

33. A computer program product for scrolling comprising:
instructions for generating a window, for displaying information and scrolling through the information responsive to a scrolling command, wherein in a current position the window displays a first portion of the information beginning at the top of the widow and ending at the bottom of the window; and
instructions for scrolling downward with a context-sensitive scrolling mode enabled, wherein if in the current position an object is a top-most object in the window and has a bottom-most end shown, then the window steps down to a next position wherein the window displays a next portion of the information beginning at the top of a next object after the current top-most object; and
instructions for scrolling downward with a context-sensitive scrolling mode enabled, wherein if in the current position the top-most object is cut off at the bottom of the window and has a bottom-most sub-object, then the window steps down to a next position wherein the window displays a next portion of the information beginning at the top of the current bottom-most sub-object.

34. The computer program product of claim 33, wherein the current top-most object has a certain sub-object that is a bottom-most sub-object shown in the current position of the window, the computer program product comprising:
instructions for scrolling downward with a context-sensitive scrolling mode enabled, wherein if in the current position the top-most object is cut off at the bottom of the window and its bottom-most sub-object has a bottom-most end shown, then the window steps down to a next position wherein the window displays a next portion of the information beginning at the top of a next sub-object after the current bottom-most sub-object.

35. The computer program product of claim 33, comprising instructions for receiving a command for context-sensitive scrolling from a pointing input device or a discrete step input device.

36. The computer program product of claim 35, wherein the pointing input device is a mouse, a trackball, a light pen, a touch screen, a track point or a touch pad.

37. The computer program product of claim 35, wherein the discrete step input device is a keyboard, a keypad or a microphone.

38. The computer program product of claim 33, wherein for a context-sensitive scrolling command received from a pointing input device, if a commanded scrolling movement exceeds a single scrolling step size, then the widow steps down multiple times through the information, pausing to display the information after each step.

39. The computer program product of claim 38, wherein the pauses are more brief for a larger commanded scrolling movement than for a smaller scrolling movement.

40. The computer program product of claim 38, wherein the pauses are more brief for a faster commanded scrolling movement than for a slower scrolling movement.

41. The computer program product of claim 33, wherein the content to which the context-sensitive scrolling responds is: a sentence, paragraph, section, division, chapter, page, hypertext link, row, column, cell, image, pause in sound, verse, stanza, refrain, interlude, movement, chorus, act, scene, commercial, quarter, half, highlight, play, time-out or bookmark.
